(19) United States
(12) Patent Application Publication
(10) Pub. No.: US 2017/0102480 A1
(43) Pub. Date: Apr. 13, 2017

(54) FIELD OF PLAY BOUNDARY DETECTION SYSTEM

(71) Applicants: Stratom, Inc., Boulder, CO (US); Fletcher Group, LLC, Burr Ridge, IL (US)

(72) Inventors: Mark ROSENBLUM, Denver, CO (US); Dan GRAINGE, Elmhurst, IL (US); Dan AMBROSIO, Denver, CO (US); Ryan Matthew DELGIZZI, Arvada, CO (US); Jon HARRACH, Erie, CO (US)

(21) Appl. No.: 15/281,521

(22) Filed: Sep. 30, 2016

Related U.S. Application Data
(60) Provisional application No. 62/239,368, filed on Oct. 9, 2015.

(51) Int. Cl. G01V 8/20; H04N 7/18

(52) U.S. Cl. CPC G01V 8/20; H04N 7/181; H04N 7/188; G06T 2207/30228

(57) ABSTRACT

A boundary detection apparatus is provided, including a laser emitter configured to emit at least a portion of a laser curtain in a plane aligned with a sports field boundary; and an imaging camera associated with the sports field boundary. The laser curtain provides a detectable indication on an object crossing the sports field boundary that is captured by the imaging camera.

### RELATED APPLICATION

This application claims priority under 35 USC 119 from U.S. Provisional Application Ser. No. 62/239,368 filed Oct. 9, 2015 which is incorporated by reference herein.

### BACKGROUND

Many sporting events have boundaries, and if a player, ball, puck, or other object crosses one or more boundaries certain events may be set in motion or points given to a team. In many cases, human officials make judgments on whether a boundary has been crossed, and in the vast majority of cases such human judgement is correct. However, in certain instances human judgment may be incorrect, which may have a large impact on the outcome of a game. In order to mitigate against such errors in human judgement that may impact a game outcome, many sports have implemented certain amounts of video review that may be performed to help correct errors that may have been made. One common form of video review may involve an official that is officiating a game reviewing a video playback of an event to confirm or change a call that was made. Some systems for sensing field-of-play boundaries in sports may also use video streams to review calls made in a game. One such system, provided by HawkEye Technologies of Basingstoke UK, combines the inputs from multiple video streams focused on the same 3D structure but from different aspect views. The video streams are combined to determine a location of an object, such as a soccer ball, to determine if the object has crossed a boundary of interest. The combination of input streams requires a significant amount of computer processing in real-time to determine if a ball or player foot crosses a field boundary.

While such video systems provide useful information, the complexity, cost, and back-end processing systems make such systems undesirable for use at some venues. Thus, it would be desirable to have a less complex and less expensive boundary detection system that can accurately and reliably provide sensing at field-of-play boundaries.

### SUMMARY

The present disclosure recognizes it would be useful to have a system to detect boundaries and relations between one or more objects and one or more boundaries. The present disclosure provides a boundary detection system that uses a laser line pattern aligned with a field boundary in combination with a camera that is sensitive to the laser wavelength to assist a referee in the review process of a play to see of a ball, foot, or other object, crossed a field boundary. The laser, in some examples, may be in the visible light spectrum or the near infrared. An imaging camera is provided in conjunction with the laser, and that is sensitive in the laser's band of wavelength, and a referee can review the imagery within the scene to determine if an object has crossed the boundary. The referee may have the ability to step through a video frame-by-frame to see if a ball, foot, or other object has laser light projected onto it. If so, then the ball, foot, or other object crossed the field boundary. This approach can prove to be more accurate and less expensive than many existing systems. Thus, the combination of laser and camera to instrument a field boundary may assist a human referee in reviewing a close play.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the spirit and scope of the appended claims. Features which are believed to be characteristic of the concepts disclosed herein, both as to their organization and method of operation, together with associated advantages will be better understood from the following description when considered in connection with the accompanying figures. Each of the figures is provided for the purpose of illustration and description only, and not as a definition of the limits of the claims. More specifically, a boundary detection apparatus is provided, including a laser emitter configured to emit at least a portion of a laser curtain in a plane aligned with a sports field boundary; and an imaging camera associated with the sports field boundary. The laser curtain provides a detectable indication on an object crossing the sports field boundary that is captured by the imaging camera.

### BRIEF DESCRIPTION OF THE DRAWINGS

FIG. 1 is an illustration of a boundary detection system and exemplary imagery provided by such a system according to various aspects of the present disclosure; and

FIG. 2 is an illustration of a laser curtain associated with multiple boundaries in a field of play according to various aspects of the present disclosure.

### DETAILED DESCRIPTION

This description provides examples, and is not intended to limit the scope, applicability or configuration of the invention. Rather, the ensuing description will provide those skilled in the art with an enabling description for implementing embodiments of the invention. Various changes may be made in the function and arrangement of elements.

Thus, various embodiments may omit, substitute, or add various procedures or components as appropriate. For instance, aspects and elements described with respect to certain embodiments may be combined in various other embodiments. It should also be appreciated that the following systems, devices, and components may individually or collectively be components of a larger system, wherein other procedures may take precedence over or otherwise modify their application.

The present disclosure is generally directed to a boundary detection system that may be implemented on any of a number of different field-of-play boundaries. In some examples, the boundary detection system uses a circular laser line pattern aligned with a field boundary in combination with a camera that is sensitive to the laser wavelength that may provide imagery associated with the boundary. Such imagery may assist a referee in the review process of a play to see of a ball, foot, or other object, crossed a field boundary. The laser, in some examples, may be in the visible light spectrum or the near infrared. An imaging camera is provided in conjunction with the laser, and that is sensitive in the laser's band of wavelength, and a referee can review the imagery within the scene to determine if an object has crossed the boundary. The referee may have the ability to step through a video frame-by-frame to see if a ball, foot, or other object has laser light projected onto it. If so, then the ball, foot, or other object crossed the field boundary. This approach can prove to be more accurate and less expensive than many existing systems. Thus, the combination of laser and camera to instrument a field boundary may assist a human referee in reviewing a close play.

The laser/camera of various aspects of this disclosure may be installed relatively simply and easily, using hardware that is relatively inexpensive in comparison to multiple high-end video cameras. Additionally, the resultant accuracy of techniques provided herein may provide enhanced accuracy relative to current systems. Furthermore, techniques described herein may require significantly less processing power to produce accurate results as compared to existing systems, and also may overcome occlusion more easily and less expensively.

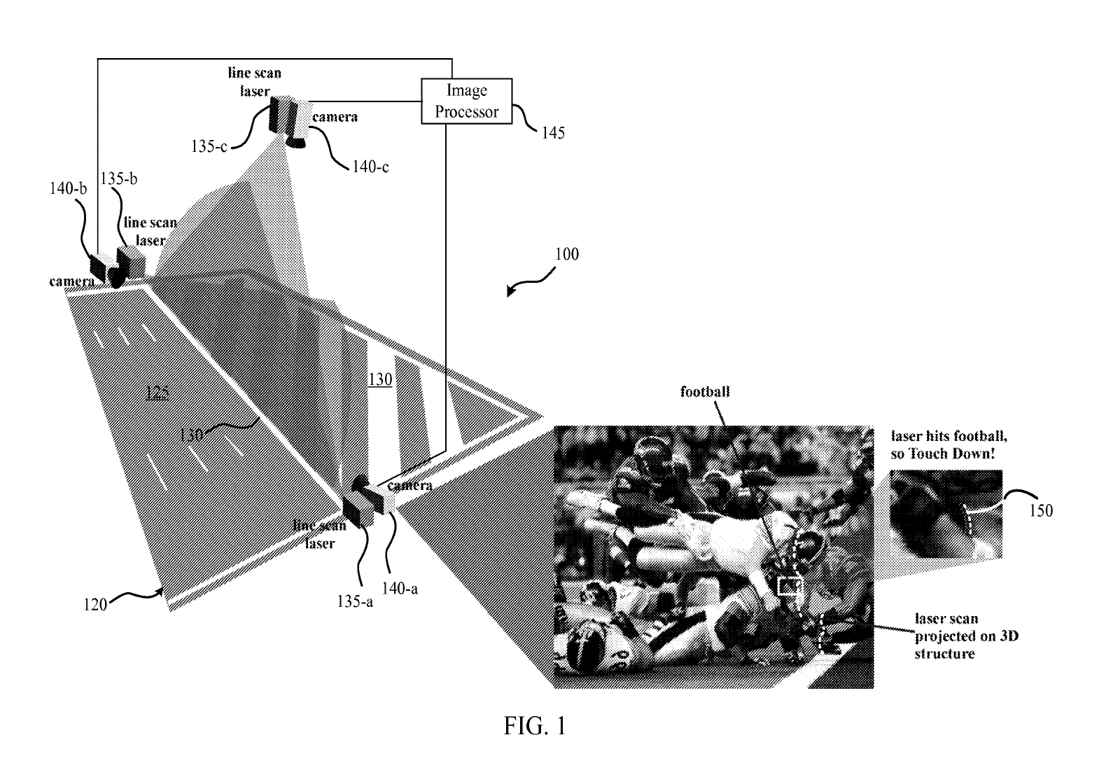

In some examples, such as illustrated in FIG. 1, a boundary detection system 100 may be set up on a playing field 120, such as an American football field that has a field of play 125 and an end zone 130 with a goal line 130 that demarcates when an object enters the end zone 130. The boundary detection system 100 may include line scan lasers 135 and cameras 140. In some examples, the boundary detection system 100 may include a set of pairs of lasers 135 and cameras 140 associated with a field-of-play boundary. In the example of FIG. 1, a first laser 135-a has an associated first camera 140-a located on a first side of the goal line 130, a second laser 140-b has an associated second camera 140-b located on a second side of the goal line 130, and a third laser 135-c has an associated third camera 140-c located above the goal line 130. While the cameras 140 are shown adjacent the corresponding lasers, 135, it is also contemplated that the cameras are optionally disposed along the field boundary opposite or facing the respective laser. Also, there may be more or fewer cameras corresponding to the number of lasers, depending on the application. In each case, the laser is aligned with the boundary such that the combination of all of the lasers creates a laser curtain that spans a plane associated with the boundary of the goal line 130. Each camera 140 may be coupled, in some examples, with an image processor 145 that may provide image processing to enhance visual properties of an image to make a laser line 130 visible, or enhance the visibility of laser line 150, on an image that may be viewed by a game official or by broadcast viewers. For example, the laser may output a near infrared laser beam that may not be visible to humans, and cameras 140 may be configured to be sensitive to the laser wavelength. The image processor 145 may be used to overlay the laser wavelength imagery onto visible spectrum images. In addition, the image processor is utilized for enhancing the visual characteristics of the objects crossing the filed boundary or the laser line 130 to better visually distinguish photographed objects from each other. For example, the image processor 145 may provide an image with a line 150 corresponding to the laser beam to clearly illustrate that an object, such as a football, has crossed the goal line 130. In addition, the image processor 145 is preferably configured for enhancing the photographed image so that the target object, such as the ball, is more readily distinguished from players' body parts.

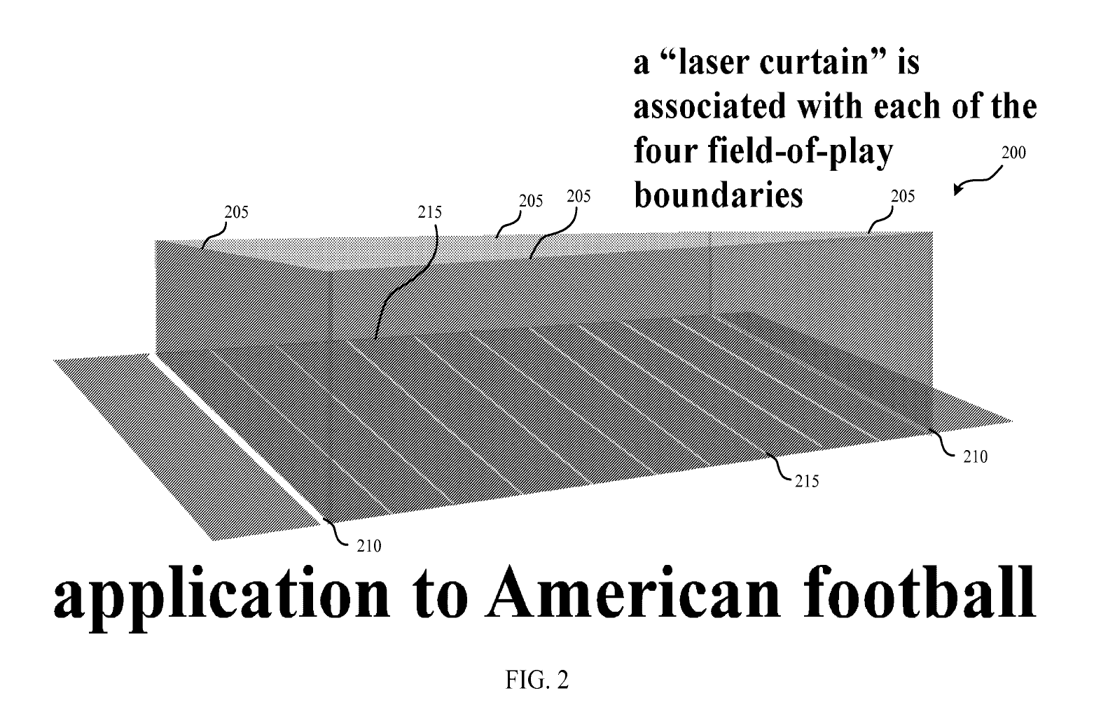

Other examples of field-of-play boundaries may include, for example, goal lines, sidelines, first down lines in American football, strike zones, foul lines, home run lines, etc. Each line may have one or more laser/camera pairs looking down the line from each direction and one or more laser/camera pairs looking straight down. The multiple views of a line may mitigate occlusion problems from other players on the field. FIG. 2 is an illustration of an American football field 200 that has laser curtains 205 similar in construction to those described in relation to FIG. 1 associated with each goal line 210 and each sideline 215. Similar laser curtains may be established for other playing fields or courts for other sporting events.

In some examples, each laser/camera pair may include a circular line laser in the visible or near infrared spectrum coupled with a camera that is sensitive to the same wavelength. If the laser wavelength is in the visible light spectrum, a green wavelength may be preferable (e.g., near 532 nm), although any other color wavelength may be implemented. In some examples, the wavelength of the laser may be selected to provide sufficient reflectivity and detection from materials of objects in interest. One advantage of the near infrared wavelength is that it is not visible by the naked human eye and requires specialized camera sensitive to that particular wavelength. Thus, a participant in a contest is less likely to be distracted by the laser curtain. Various aspects may provide imagery with the laser line projected onto it to a referee for review. Such imagery may include video imagery that is easily comprehendible for human review without significant amounts of technical training. In some examples, human readability is enhanced through the use of a multi-spectral camera that is essentially a color camera (red, green, blue) with a forth near infrared imaging plane. The near infrared pixels may be aligned with the color pixels in the sensor, so the laser projection sensed on the infrared plane can be reprojected onto the color image. The camera independent of its spectral sensitivity may also provide a relatively high frame rate (e.g., >120 fps) and a relatively short shutter speed (e.g., 1/180 sec). The video captured from some camera systems may be playable at slow speeds and frame-by-frame, and the laser projection included in the imagery may be used to assist with boundary detection and determination of whether an object or portion of a player's body may have crossed the boundary.

In some examples, one or more of the laser/camera pairs may be actuated along rails or cables to account for moving boundaries (e.g., a first down line in American football). Each laser/camera pair may include, for example, a near infrared circular line laser so the laser scan will not be visible to the naked eye, and a high frame rate multi-spectral video camera sensitive in near infrared wavelengths. In some examples, two or more lasers may be associated with a single camera (e.g., high and low positions lasers with a centrally positioned camera), or two or more cameras may be associated with a single laser. Some examples may also include a processing system, such as image processor 145 of FIG. 1, that runs software to ingest and process data from the appropriate set of laser/camera pairs associated with a field-of-play boundary. Such software may produce human viewable output imagery that shows the near infrared invisible laser line projection on a color image for referee review or broadcasting.

As mentioned, multiple lasers and multiple cameras may be associated with each boundary of interest. Each laser or camera may be used to provide a different aspect view of a field-of-play boundary. The laser may be configured and installed to emit a laser line pattern in which the line is aligned with the boundary of the field-of-play. The line pattern forms a circle but only the line portions that hit critical 3D structure (e.g., a ball that may cross the boundary) are important. Some of the circle emitted by the lasers may be projected into the sky or the ceiling of the stadium. In examples that use one or more multispectral camera, the output of such camera(s) may provide relatively easy viewing of the near infrared laser line on the near infrared image plane of the sensor. These high intensity pixels that correspond to the laser light may then be reprojected onto a pixel registered color image aligned with the near infrared image using a vibrant color relative to the scene. In this way, a human viewer will see a virtual line overlaid onto the color image. If this line is projected on a ball or foot in question, then the ball or foot has crossed a vertical wall emanating from the field-of-play boundary. This could signify a touchdown, first down or stepping out-of-bounds, for example. As mentioned, a processor or server may run software to ingest the sensor data and fuse it to produce a color image with the virtual laser line projection. This processed image may then be presented on a display for viewing by a referee, who may have an interface to slow the video down and view the video stream frame-by-frame in a forward and/or reverse direction. In some examples, a broadcast production crew may also have access to a similar interface so the stream can be broadcast to the viewing audience.

While many of the examples provided herein describe a near infrared laser, other examples may use a laser wavelength can be in the visible spectrum, such as red or green. This would allow for the line to show up in a regular color camera that has no sensitivity in the near infrared. Such deployments may allow a multi-spectral camera to be be replaced by a visible spectrum camera.

It should be noted that the systems and devices discussed above are intended merely to be examples. It must be stressed that various embodiments may omit, substitute, or add various procedures or components as appropriate. For instance, it should be appreciated that, in alternative embodiments, features described with respect to certain embodiments may be combined in various other embodiments. Different aspects and elements of the embodiments may be combined in a similar manner. Also, it should be emphasized that technology evolves and, thus, many of the elements are exemplary in nature and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, structures, and techniques have been shown without unnecessary detail in order to avoid obscuring the embodiments.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A boundary detection apparatus, comprising:
a laser emitter configured to emit at least a portion of a laser curtain in a plane aligned with a sports field boundary; and
an imaging camera associated with the sports field boundary,
wherein the laser curtain provides a detectable indication on an object crossing the sports field boundary that is captured by the imaging camera.

2. The apparatus of claim 1, wherein the laser emitter is configured to emit at a first wavelength and the imaging camera is configured to capture images at the first wavelength.

3. The apparatus of claim 1, further comprising:
an image processor coupled with the imaging camera that outputs processed images with a visual indication of the object penetrating the laser curtain.

4. The apparatus of claim 3, wherein:
the laser emitter is configured to emit at a wavelength outside of the visible light spectrum,
the imaging camera images comprises one or more filters sensitive to the wavelength outside of the visible light spectrum,
the imaging camera outputs a filtered image and an unfiltered visible wavelength images that correspond to the filtered image, and
the image processor is configured to overlay the filtered image on the unfiltered image to provide a resultant image that includes the visual indication of the object penetrating the laser curtain.

5. The apparatus of claim 4, wherein the laser emitter is configured to emit at a near infrared wavelength.

6. The apparatus of claim 1, wherein the object comprises one or more of a ball, a body part, or piece of equipment.

7. The apparatus of claim 1, wherein the apparatus comprises a plurality of laser emitters located at different locations around the sports field boundary that each emit at least a portion of the laser curtain in the plane aligned with the sports field boundary.

8. The apparatus of claim 7, wherein the different locations are selected to reduce occlusions of the object from players or equipment located between one of the laser emitters and the object.

9. The apparatus of claim 7, wherein the apparatus comprises a plurality of imaging cameras located at a plurality of locations around the sports field boundary.

10. The apparatus of claim 9, wherein the plurality of locations are selected to reduce occlusions of the object from players or equipment located between one of the imaging cameras and the object.

11. The apparatus of claim 9, wherein the number of laser emitters is different than the number of cameras.
